(19) United States
(12) Patent Application Publication
(10) Pub. No.: US 2007/0030287 A1
(43) Pub. Date: Feb. 8, 2007

(54) VISUAL COMPARISON OF DATA SET WITH DATA SUBSET

(75) Inventor: Pavel Buran, Prague (CZ)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/161,477

(22) Filed: Aug. 4, 2005

(51) Int. Cl. G09G 5/00

(52) U.S. Cl. 345/629

(57) ABSTRACT

A subset of a data set may be investigated by graphically comparing the subset of the data set with the whole of the data set. In some instances, a graphical representation of the data set is displayed, and a data subset of the data set is selected. A graphical representation of the data subset is displayed such that the graphical representation of the data set and the graphical representation of the data subset are superimposed. In some instances, the graphical representation of the data subset is superimposed onto the graphical representation of the data set.

### TECHNICAL FIELD

The present invention is directed generally to methods of displaying and comparing data and is directed more particularly to methods of comparing a portion of a data set to the whole of the data set.

### BACKGROUND

As computers increase in computational power, the ability to obtain and store large amounts of data continues to increase. In many instances, the amount of data pertaining to a question or issue of interest exceeds a person's ability to process the data in a timely fashion. It can be difficult to spot trends within huge amounts of alphanumeric data, particularly in large amounts of numerical data.

Graphical representation of numerical data can provide a person with a greater ability to spot trends or perceive other relevant information from the numerical data. One such graphical representation of numerical data is known as a box-and-whisker plot, frequently referred to simply as a box plot. As is known, a box plot can provide a graphical representation of particular statistical information pertaining to a data set that includes a number of values for a single variable.

A box plot permits a person to visually ascertain, for example, if a particular data set is closely clumped together, or if the data is relatively spread out. In some ways, a box plot may be considered as quickly providing a rough indication of what could be calculated as the standard deviation of the data.

However, a need remains for methods in which a portion of a data set can be further investigated, such as by graphically comparing a portion or subset of a data set with a whole or a large portion of the data set.

### SUMMARY

The present invention pertains to methods of investigating a subset of a data set by graphically comparing one or more parameters that are related to the subset of the data set with the whole or a larger portion of the data set.

An illustrative embodiment of the present invention includes a method of analyzing a data set. A data subset of the data set can be selected. A graphical representation of one or more parameters derived from the data set is displayed. A graphical representation of one or more parameters derived from the data subset is displayed such that the graphical representation of the one or more parameters derived from the data set and the graphical representation of the one or more parameters derived from the data subset are superimposed. In some instances, the graphical representation of the one or more parameters derived from the data subset is superimposed onto the graphical representation of the one or more parameters derived from the data set.

Displaying a graphical representation of one or more parameters derived from the data set may include graphically displaying one or more statistical parameters related to the data set. In some instances, this may include displaying a box plot of the data set. Displaying a graphical representation of one or more parameters derived from the data subset may include graphically displaying graphically displaying one or more statistical parameters related to the data subset. In some instances, this may include displaying a box plot of the data subset.

Another illustrative embodiment of the present invention may be found in a method of analyzing data that includes a plurality of data sets. A data set is selected, and a portion of the selected data set is selected. A box plot of the selected data set is displayed and a box plot of the selected portion of the selected data set is displayed such that the box plot of the selected portion and the box plot of the selected data set are superimposed.

The box plot of the selected portion of the selected data set may be displayed on a computer display. The box plot of the selected data set may also be displayed on a computer display. In some instances, the box plot of the selected portion of the data set is superimposed onto the box plot of the selected data set. Selecting a data set may include accessing a data set that has previously been entered. In some instances, selecting a data set may include a user inputting a data set.

Another illustrative embodiment of the present invention may be found in a method of analyzing data that includes at least a first data set and a second data set. A portion of the first data set is selected. A box plot of the first data set is displayed. A box plot of the selected portion of the first data set is displayed such that the box plot of the first data set and the box plot of the selected portion of the first data set are superimposed. In some instances, the box plot of the selected portion of the first data set may be superimposed onto the box plot of the first data set.

A portion of the second data set is selected. A box plot of the second data set is displayed. A box plot of the selected portion of the second data set is displayed such that the box plot of the second data set and the box plot of the selected portion of the second data set are superimposed. In some instances, the box plot of the selected portion of the second data set may be superimposed onto the box plot of the second data set. More than two data sets may be used, if desired.

Another illustrative embodiment of the present invention may be found in a computer program storage medium readable by a computing system and encoding a computer program for executing a computer process. The computer process includes allowing a user to select a data set, then to select a portion of the selected data set. A box plot of the selected data set is displayed. A box plot of the selected portion of the selected data set is displayed such that the box plot of the selected portion and the box plot of the selected data set are superimposed.

In some instances, the box plot of the selected portion is superimposed onto the box plot of the selected data set. In some cases, the box plot of the selected data set and the box plot of the selected portion of the selected data set are displayed on a computer display.

The above summary of the present invention is not intended to describe each disclosed embodiment or every implementation of the present invention. The Figures, Detailed Description and Examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a block diagram of a computer system in accordance with an illustrative embodiment of the present invention;

FIG. 2 is a flow diagram showing an illustrative method that may be implemented using the computer system of FIG. 1;

FIG. 3 is a flow diagram showing an illustrative method that may be implemented using the computer system of FIG. 1;

FIG. 4 is a flow diagram showing an illustrative method that may be implemented using the computer system of FIG. 1;

FIG. 5 is a flow diagram showing an illustrative method that may be implemented using the computer system of FIG. 1;

FIG. 6 is a flow diagram showing an illustrative method that may be implemented using the computer system of FIG. 1;

FIG. 7 is a flow diagram showing an illustrative method that may be implemented using the computer system of FIG. 1;

FIG. 8 is a flow diagram showing an illustrative method that may be implemented using the computer system of FIG. 1;

FIG. 9 is a flow diagram showing an illustrative method that may be implemented using the computer system of FIG. 1;

FIG. 10 is a flow diagram showing an illustrative method that may be implemented using the computer system of FIG. 1;

FIG. 11 is a flow diagram showing an illustrative method that may be implemented using the computer system of FIG. 1;

FIG. 12 is a flow diagram showing an illustrative method that may be implemented using the computer system of FIG. 1;

FIG. 13 is a flow diagram showing an illustrative method that may be implemented using the computer system of FIG. 1; and

FIG. 14 shows an illustrative output from the computer system of FIG. 1.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

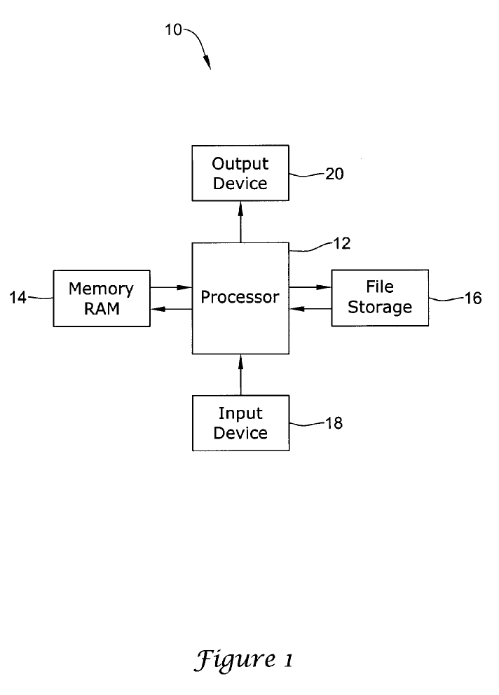

FIG. 1 diagrammatically shows a computer system 10 in accordance with an illustrative embodiment of the present invention. Computer system 10 includes processor 12 that includes circuitry permitting processor 12 to accept input, perform calculations on the information inputted to it, and to provide output resulting from the calculations. Processor 12 communicates with memory 14, such as RAM, as well as with file storage 16, which can include a hard drive, tape drive, or the like. File storage 16 may be used to store data as well as programs used by processor 12 to process the data. Memory 14 may be used by processor 12 for transient storage.

Illustrative computer system 10 also includes an input device 18 and an output device 20. Input device 18 permits an operator to provide data or other input to processor 12 while output device 20 permits processor 12 to communicate with the operator. Input device 18 may include a keyboard, mouse, floppy disc drive, optical drive such as a CD-drive or DVD-drive, a network card, or the like. Output device 20 may include a display device such as a CRT or an LCD display, or a printer. In some instances, input device 18 may include internet data entry while in some cases output device 20 may include a website providing output to the internet, if desired.

Computer system 10 may be adapted to, for example, provide a box plot of a data set, in combination with a box plot of a data subset of the data set. In some instances, computer system 10 may permit a user to further investigate a portion of a data set. While computer system 10 is described herein as being adapted to provide a box plot of a data subset in combination with a box plot of a larger portion or the whole of a data set, it is contemplated that computer system 10 may be adapted to further drill down, i.e., provide a box plot of a portion of the data subset, a box plot of a segment of the portion of the data subset, etc.

Also, and more generally, computer system 10 may provide a graphical representation of one or more parameters related to a subset of a data set superimposed or otherwise displayed with a graphical representation of one or more parameters related to the whole or larger part of the data set. A box plot is just one illustrative graphical representation contemplated by the present invention. Further, the parameters need not only be parameters related to a single variable data set, but rather may relate to a portion of a multi-variable data set.

In constructing a box plot of a set of numerical data, the individual numbers are at least conceptually organized in numerical order. The median of the data set is the middle of the organized numbers. A first quartile may represent a median of the lower half of the data, i.e., below the median of the data set while a fourth quartile may represent a median of the upper half of the data. A box may then be drawn having vertical lines extending through the first quartile and the third quartile. Another vertical line may cut through the box and extends through the data median.

Lines extending horizontally to the smallest and largest numbers may also be provided, assuming that neither of the smallest and largest numbers represent outliers that are well outside the rest of the data range. In some instances, the smallest number can be referred to as the lower adjacent value, and may be set as a function of spacing from the first quartile. Similarly, the largest number can be referred to as the upper adjacent value and may be set as a function of spacing from the third quartile. In some instances, vertical lines may be drawn through the lower adjacent value and the upper adjacent value.

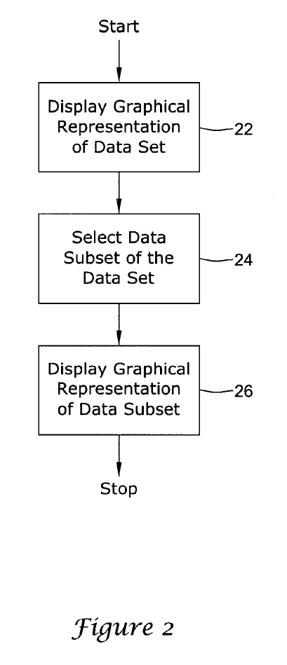

FIG. 2 is a flow diagram showing an illustrative method that may be implemented by computer system 10 (FIG. 1). At block 22, a graphical representation of a data set is displayed. In some instances, this may be accomplished via processor 10 (FIG. 1) commanding output device 20 (FIG. 1) to display a graphical representation of the data set. This may include graphically showing statistical data or parameters that are related to or, derived from, the data set. In some instances, this may include a box plot of the data set, as described above.

At block 24, a data subset of the data set is selected. In some instances, a user may provide processor 12 (FIG. 1), via input device 18 (FIG. 1), information pertaining to which portion or portions of the data set is to be selected as the data subset. The user may select the portion or portions of the data set based on the graphical representation of the data set, i.e., the graphical representation may show a clustering or clumping of data bearing closer investigation, or in any other suitable way. The data set may represent, for example, a set of readings such as sensor readings taken in chronological order and the user may decide to select a subset representing a particular time period within the larger time period represented by the data set.

At block 26, a graphical representation of the data subset is displayed. In some instances, this may be accomplished via processor 10 (FIG. 1) commanding output device 20 (FIG. 1) to display a graphical representation of the data subset. This may include graphically showing statistical data that is related to or, derived from, the data subset. In some instances, this may include a box plot of the data subset.

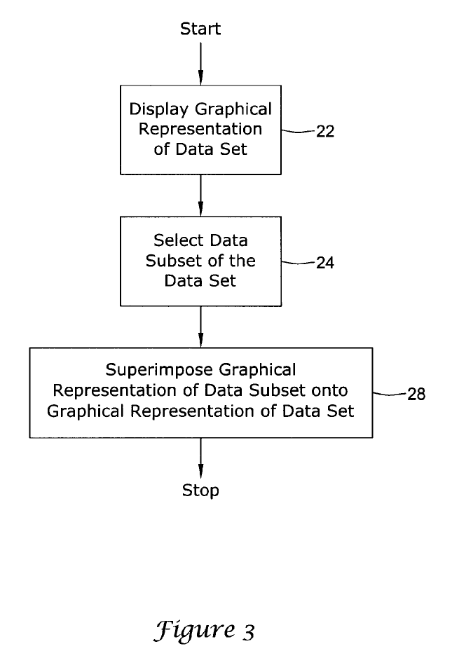

FIG. 3 shows a similar method. In FIG. 3, a graphical representation of a data set is displayed at block 22. As noted, this may be accomplished via processor 10 (FIG. 1) commanding output device 20 (FIG. 1) to display a graphical representation of the data set, such as statistical data or parameters related to the data set or even a box plot of the data set.

At block 24, a data subset of the data set is selected. In some instances, a user may provide processor 12 (FIG. 1), via input device 18 (FIG. 1), information pertaining to which portion or portions of the data set is to be selected as the data subset.

At block 28, a graphical representation of the data subset, such as statistical data or parameters related to the data subset or even a box plot of the data subset, is superimposed onto the data representation of the data set. In some instances, processor 12 (FIG. 1) may instruct output device 20 (FIG. 1) to superimpose the graphical representation of the data subset onto the graphical representation of the data set. As a result, the data subset may be quickly and visually compared with the data set itself.

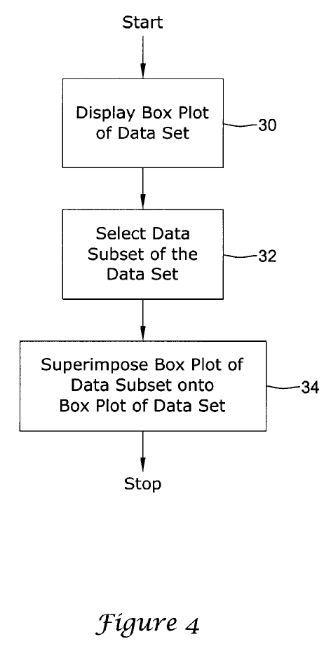

FIG. 4 shows another illustrative method that may be carried out by computer system 10 (FIG. 1). At block 30, a box plot of a data set is displayed. In some instances, processor 12 (FIG. 1) may instruct output device 20 (FIG. 1) to display the box plot. At block 32, a data subset of the data set is selected. As discussed previously, a user may use input device 18 (FIG. 1) to instruct processor 12 as to the identity of the data subset. At block 34, a box plot of the data subset is superimposed onto the box plot of the data set, as may be accomplished by processor 12 outputting the superimposed box plots to output device 20.

It should be noted that although these flow diagrams are discussed as being in chronological order, it is not necessary that each of these steps occur in the order discussed. For example, while the steps may occur in the order discussed, it should be noted that in some cases steps may occur in different orders. In some instances, steps may occur simultaneously, or sequentially in any desired order.

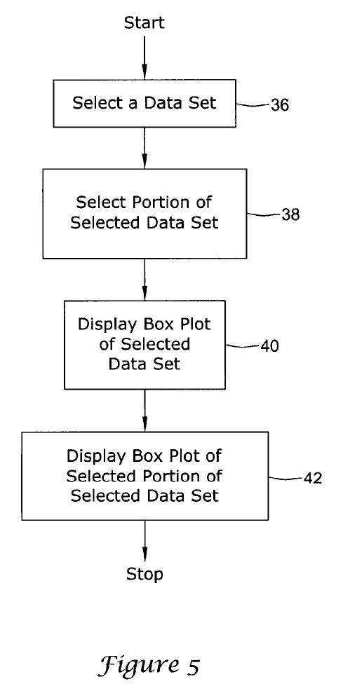

FIG. 5 shows another illustrative method that may be carried out by computer system 10 (FIG. 1). At block 36, a data set is selected. This may entail processor 12 (FIG. 1) accessing a data set previously put into memory 14 (FIG. 1) or file storage 16 (FIG. 1). In some cases, processor 12 provides, via output device 20, several data set from which a user may select. In some instances, selecting a data set may entail a user entering a data set via input device 18 (FIG. 1). At block 38, a portion of the selected data set is selected, in a manner previously discussed.

At block 40, a box plot of the selected data set is displayed. In some instances, the box plot of the selected data set may be outputted via output device 20 (FIG. 1). At block 42, a box plot of the selected portion of the selected data set is displayed. In some instances, the box plot of the selected portion of the selected data set may be displayed simultaneously with the box plot displayed at block 38 such that they can be compared visually.

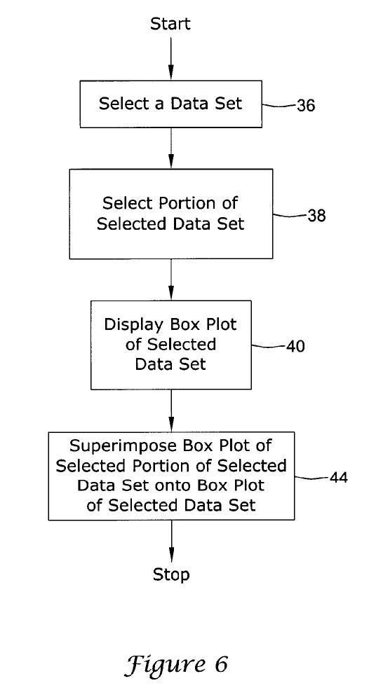

FIG. 6 shows another illustrative method that may be carried out by computer system 10 (FIG. 1). At block 36, a data set is selected. This may entail processor 12 (FIG. 1) accessing a data set previously put into memory 14 (FIG. 1) or file storage 16 (FIG. 1). In some cases, processor 12 provides, via output device 20, several data set from which a user may select. In some instances, selecting a data set may entail a user entering a data set via input device 18 (FIG. 1). At block 38, a portion of the selected data set is selected, in a manner previously discussed.

At block 40, a box plot of the selected data set is displayed. In some instances, the box plot of the selected data set may be outputted via output device 20 (FIG. 1). At block 44, a box plot of the selected portion of the selected data set is superimposed onto the box plot of the selected data set. In some instances, the superimposed box plots may be outputted via output device 20 (FIG. 1). A user may then compare the box plots visually.

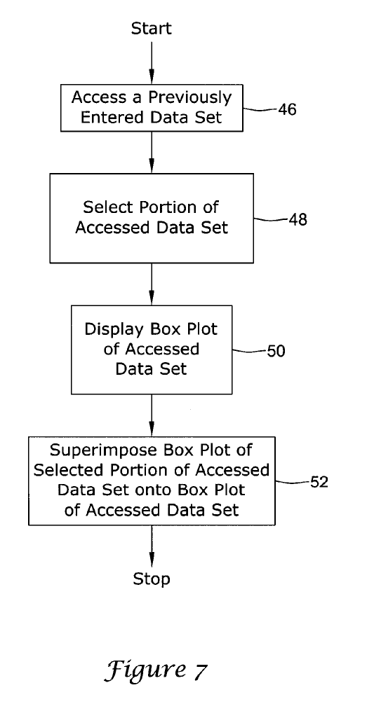

FIG. 7 shows another illustrative method that may be carried out by computer system 10 (FIG. 1). At block 46, a previously entered data set is accessed. This may be accomplished by processor 12 (FIG. 1) accessing a data set previously put into memory 14 (FIG. 1) or file storage 16 (FIG. 1). At block 48, a portion of the accessed data set is selected, in a manner previously discussed.

At block 50, a box plot of the accessed data set is displayed. In some instances, the box plot of the accessed data set may be outputted via output device 20 (FIG. 1). At block 52, a box plot of the selected portion of the accessed data set is superimposed onto the box plot of the accessed data set. In some instances, the superimposed box plots may be outputted via output device 20 (FIG. 1). A user may then compare the box plots visually.

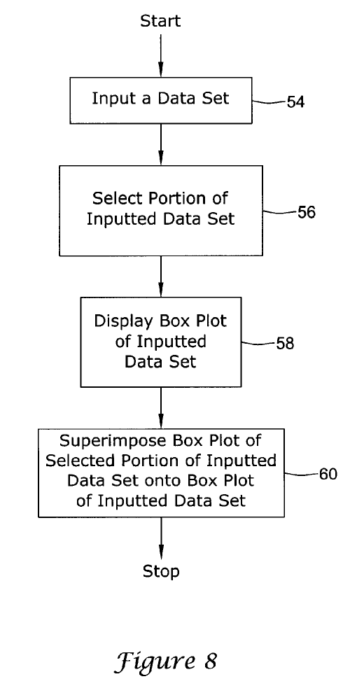

FIG. 8 shows another illustrative method that may be carried out by computer system 10 (FIG. 1). At block 54, a data set is inputted. This may be accomplished by permitting a user to enter a data set via input device 18 (FIG. 1). Depending on the size of the data set, a user may manually enter the data via a keyboard. In some instances, the user may input the data via a CD or DVD, or by pasting the data set in from another computer program such as a spreadsheet program. At block 56, a portion of the inputted data set is selected, in a manner previously discussed.

At block 58, a box plot of the inputted data set is displayed. In some instances, the box plot of the inputted data set may be outputted via output device 20 (FIG. 1). At block 60, a box plot of the selected portion of the inputted data set is superimposed onto the box plot of the inputted data set. In some instances, the superimposed box plots may be outputted via output device 20 (FIG. 1). A user may then compare the box plots visually.

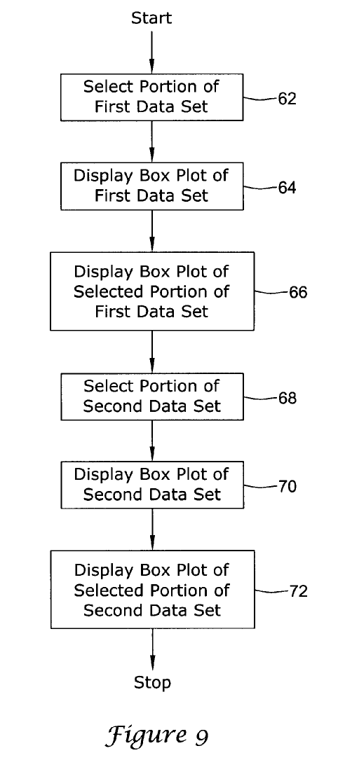

FIG. 9 shows another illustrative method that may be carried out by computer system 10 (FIG. 1). In some instances, a set of data may include at least a first data set and a second data set. At block 62, a portion of the first data set is selected, in a manner previously discussed. At block 64, a box plot of the first data set is displayed. In some instances, the box plot of the first data set may be outputted via output device 20 (FIG. 1). At block 66, a box plot of the selected portion of the first data set is displayed, perhaps via output device 20.

At block 68, a portion of the second data set is selected. At block 70, a box plot of the second data set is displayed. In some instances, the box plot of the second data set may be outputted via output device 20 (FIG. 1). At block 72, a box plot of the selected portion of the second data set is displayed, perhaps via output device 20.

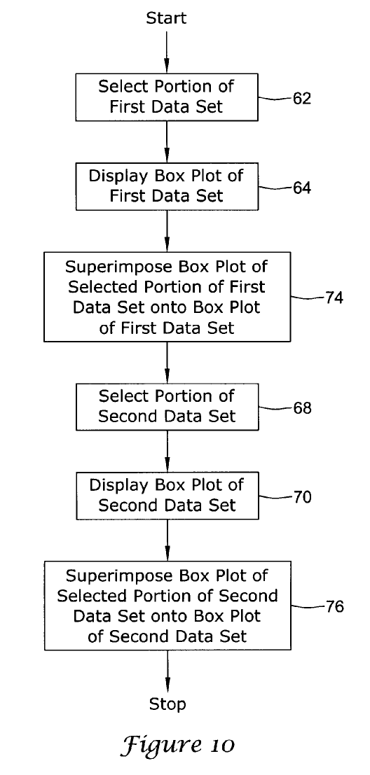

FIG. 10 shows another illustrative method that may be carried out by computer system 10 (FIG. 1) in analyzing a set of data that includes at least a first data set and a second data set. At block 62, a portion of the first data set is selected, in a manner previously discussed. At block 64, a box plot of the first data set is displayed. In some instances, the box plot of the first data set may be outputted via output device 20 (FIG. 1). At block 74, a box plot of the selected portion of the first data set is superimposed onto the box plot of the first data set.

At block 68, a portion of the second data set is selected. At block 70, a box plot of the second data set is displayed. In some instances, the box plot of the second data set may be outputted via output device 20 (FIG. 1). At block 76, a box plot of the selected portion of the second data set is superimposed onto the box plot of the second data set.

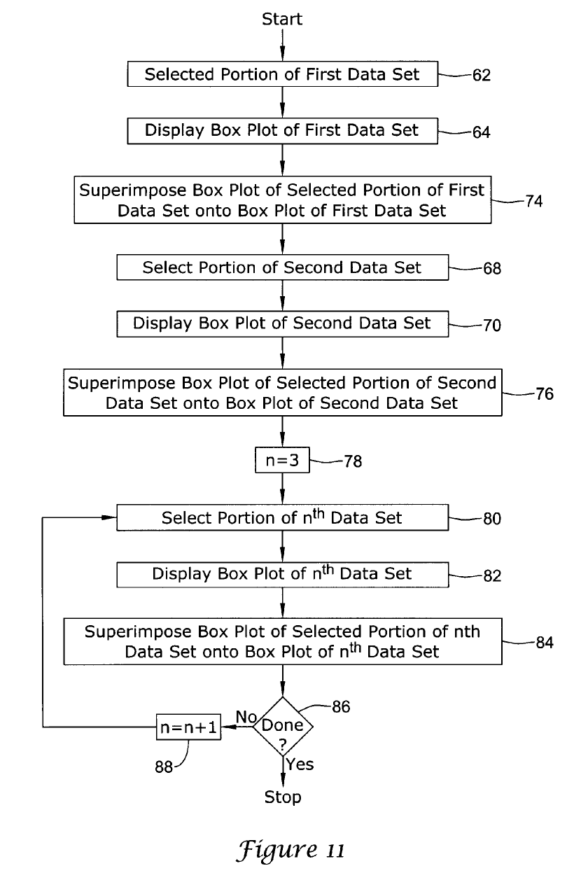

FIG. 11 shows another illustrative method that may be carried out by computer system 10 (FIG. 1 ) in analyzing a set of data that includes at least a first data set, a second data set and an n^{th} data set. At block 62, a portion of the first data set is selected, in a manner previously discussed. At block 64, a box plot of the first data set is displayed. In some instances, the box plot of the first data set may be outputted via output device 20 (FIG. 1). At block 74, a box plot of the selected portion of the first data set is superimposed onto the box plot of the first data set.

At block 68, a portion of the second data set is selected. At block 70, a box plot of the second data set is displayed. In some instances, the box plot of the second data set may be outputted via output device 20 (FIG. 1). At block 76, a box plot of the selected portion of the second data set is superimposed onto the box plot of the second data set.

At block 78, counter n is set equal to 3. A portion of the n^{th} data set is selected at block 80. At block 82, a box plot of the n^{th} data set is displayed, and a box plot of the selected portion of the n^{th} data set is superimposed onto the box plot of the n^{th} data set at block 84. At decision block 86, processor 12 (FIG. 1) determines if all of the data set have been analyzed. If so, the method stops. If not, control passes to block 88 where counter n is incremented by 1, and control then returns to block 80.

In some instances, data may include a large number of data set, and all of the data may be processed sequentially by displaying a box plot of a given data set and superimposing thereon a box plot of a selected portion of the given data set. In some cases, a user is given the opportunity to select, via input device 18 (FIG. 1), which of the many data sets are to be analyzed in the manner discussed herein.

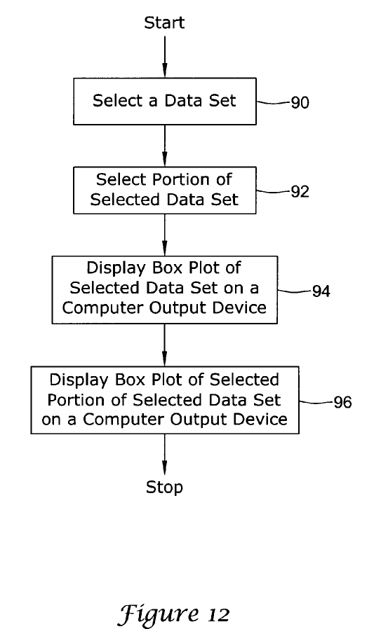

FIG. 12 shows another illustrative method that may be implemented by computer system 10 (FIG. 1). At block 90, a data set is selected. This may include accessing a previously entered data set or permitting a user to input a data set. A portion of the selected data set is selected at block 92. The selected portion may be determined in any manner such as previously discussed.

At block 94, a box plot of the selected data set is displayed on a computer output device such as output device 20 (FIG. 1). At block 96, a box plot of the selected portion of the selected data set is displayed on a computer output device such as output device 20 (FIG. 1), such that the box plot of the selected portion may be visually compared with the box plot of the selected data set itself.

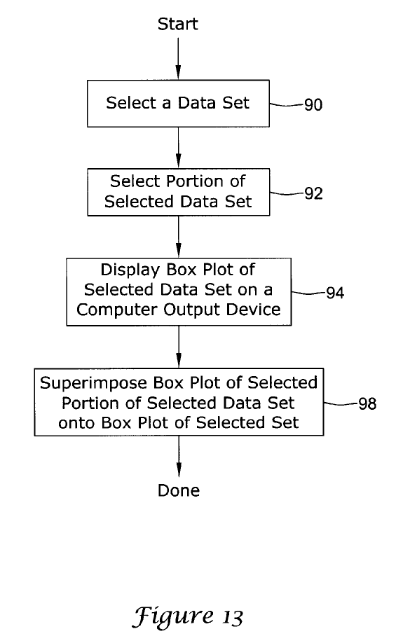

FIG. 13 shows another illustrative method that may be implemented by computer system 10 (FIG. 1). At block 90, a data set is selected. This may include accessing a previously entered data set or permitting a user to input a data set. A portion of the selected data set is selected at block 92. The selected portion may be determined in any manner such as previously discussed. At block 94, a box plot of the selected data set is displayed on a computer output device such as output device 20 (FIG. 1). At block 98, a box plot of the selected portion of the selected data set is superimposed onto the box plot of the selected data set. The superimposed box plots may be displayed on a computer output device such as output device 20 (FIG. 1).

### EXAMPLE

This shows one example of the present invention. The example was implemented on a personal computer running Decision Support Suite (DSS), which is a software suite available to the assignee of the present invention. However, the methods shown herein are not limited to such an implementation. For example, the invention may be implemented on computer system 10 (FIG. 1), as discussed previously.

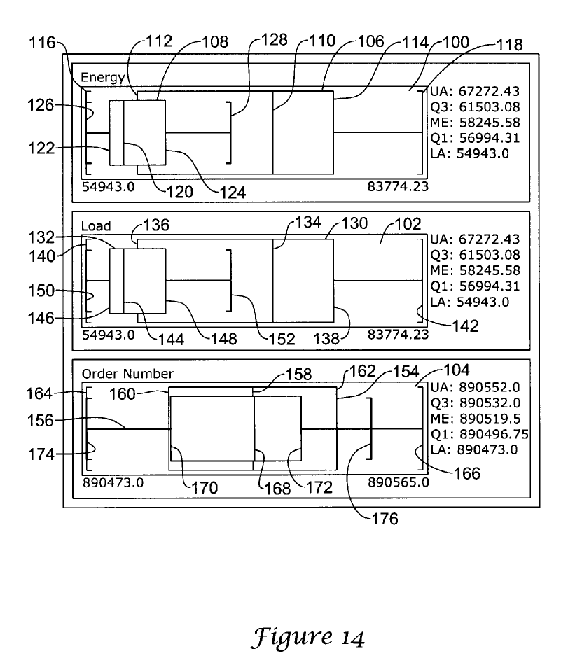

FIG. 14 shows a set of box plots representing the numerical data presented in Table 1. The data represents energy, load and order number data corresponding to a set of time points. It can be seen that for the purposes of this example, the same time points were employed in selecting the data subsets corresponding to energy data, load data, and order number data. In particular, the energy, load and order number data corresponding to early morning time points were selected. It should be recognized, however, in analyzing data sets that different criteria may be employed in selecting the subset corresponding to each data set.

In FIG. 14, the first nested box plot 100 graphically represents the energy data, the second nested box plot 102 graphically represents the load data, and the third nested box plot 104 graphically represents the order number data. First nested box plot 100 includes a box plot 106 representing all of the energy data and a box plot 108 that represents the selected portion of the energy data.

Box plot 106 includes a median line 110, a first quartile line 112, a third quartile line 114, a lower adjacent value line 116 and an upper adjacent value line 118. Box plot 108 includes a median line 120, a first quartile line 122, a third quartile line 124, a lower adjacent value line 126 and an upper adjacent value line 128.

As the data represented by box plot 108 includes the lowest energy values included in the data represented by box plot 106, it can be seen that lower adjacent value line 116 and lower adjacent value line 126 are common to each other. By comparing box plot 108 to box plot 106, it can be seen that, as would be expected in this example, energy use during early morning hours is relatively light compared to all energy usage data. This can be seen, for example, by noting that upper adjacent value line 128 of box plot 108 represents a lower number than median line 110 of box plot 106. Similarly, median line 120 of box plot 108 represents a lower number than first quartile line 112 of box plot 106.

Similarly, second nested box plot 102 includes a box plot 130 representing all of the load data and a box plot 132 that represents the selected portion of the load data. Box plot 130 includes a median line 134, a first quartile line 136, a third quartile line 138, a lower adjacent value line 140 and an upper adjacent value line 142. Box plot 132 includes a median line 144, a first quartile line 146, a third quartile line 148, a lower adjacent value line 150 and an upper adjacent value line 152.

As the data represented by box plot 132 includes the lowest load values included in the data represented by box plot 130, it can be seen that lower adjacent value line 140 and lower adjacent value line 150 are common to each other. By comparing box plot 132 to box plot 130, it can be seen that, as would be expected in this example, load values during early morning hours are relatively light compared to all load value data. This can be seen, for example, by noting that upper adjacent value line 152 of box plot 132 represents a lower number than median line 134 of box plot 130. Similarly, median line 144 of box plot 132 represents a lower number than first quartile line 136 of box plot 130.

Moreover, third nested box plot 104 includes a box plot 154 representing all of the order number data and a box plot 156 that represents the selected portion of the order number data. Box plot 154 includes a median line 158, a first quartile line 160, a third quartile line 162, a lower adjacent value line 164 and an upper adjacent value line 166. Box plot 156 includes a median line 168, a first quartile line 170, a third quartile line 172, a lower adjacent value line 174 and an upper adjacent value line 176.

By comparing box plot 156 with box plot 154, it can be seen that the order numbers corresponding to the selected subset are fairly well dispersed throughout all of the order number data. This can be seen by noting that median line 158 of box plot 154 represents a number very close to that represented by median line 168 of box plot 156. First quartile line 160 of box plot 154 is quite close to first quartile line 170 of box plot 156. Indeed, the only significant difference shown between box plot 154 and box plot 156 is that, since the data selected for box plot 156 represents only early morning data, and the data extends (as can be seen in Table 1 below) until evening, the highest order numbers are excluded from box plot 156. This is to be expected in this particular example, as the order number is merely a counter.

TABLE 1

| | | | Order | |
|---|---|---|---|---|
| TimePoint | Energy | Load | Number | Part of Subset? |
| 7/31/2001 1:00 | 60107.12 | 60409.17 | 890473 | yes |
| 7/31/2001 2:00 | 57960.99 | 57960.99 | 890474 | yes |
| 7/31/2001 3:00 | 56383.66 | 56383.66 | 890475 | yes |
| 7/31/2001 4:00 | 55360.63 | 55360.63 | 890476 | yes |
| 7/31/2001 5:00 | 55602.69 | 55602.69 | 890477 | yes |
| 7/31/2001 6:00 | 57850.27 | 57850.27 | 890478 | yes |
| 7/31/2001 7:00 | 58527.49 | 58527.49 | 890479 | yes |
| 7/31/2001 8:00 | 62613.38 | 62613.38 | 890480 | yes |
| 7/31/2001 9:00 | 70429.92 | 70429.92 | 890481 | no |
| 7/31/2001 10:00 | 71508.79 | 71508.79 | 890482 | no |
| 7/31/2001 11:00 | 76022.78 | 76022.78 | 890483 | no |
| 7/31/2001 12:00 | 74940.09 | 74940.09 | 890484 | no |
| 7/31/2001 13:00 | 80016.36 | 80016.36 | 890485 | no |
| 7/31/2001 14:00 | 82363.11 | 82363.11 | 890486 | no |
| 7/31/2001 15:00 | 83774.23 | 83774.23 | 890487 | no |
| 7/31/2001 16:00 | 83337.52 | 83337.52 | 890488 | no |
| 7/31/2001 17:00 | 80404.02 | 80404.02 | 890489 | no |
| 7/31/2001 18:00 | 78359.17 | 78359.17 | 890490 | no |
| 7/31/2001 19:00 | 76245.20 | 76245.20 | 890491 | no |
| 7/31/2001 20:00 | 73529.22 | 73529.22 | 890492 | no |
| 7/31/2001 21:00 | 72839.58 | 72839.58 | 890493 | no |
| 7/31/2001 22:00 | 73219.86 | 73219.86 | 890494 | no |
| 7/31/2001 23:00 | 69755.95 | 69755.95 | 890495 | no |
| 8/1/2001 0:00 | 65216.76 | 65216.76 | 890496 | yes |
| 8/1/2001 1:00 | 61585.72 | 61585.72 | 890497 | yes |
| 8/1/2001 2:00 | 59427.84 | 59427.84 | 890498 | yes |
| 8/1/2001 3:00 | 57867.12 | 57867.12 | 890499 | yes |
| 8/1/2001 4:00 | 56855.11 | 56855.11 | 890500 | yes |
| 8/1/2001 5:00 | 57040.71 | 57040.71 | 890501 | yes |
| 8/1/2001 6:00 | 58266.35 | 58266.35 | 890502 | yes |
| 8/1/2001 7:00 | 59584.75 | 59584.75 | 890503 | yes |
| 8/1/2001 8:00 | 63551.24 | 63551.24 | 890504 | yes |
| 8/1/2001 9:00 | 70079.78 | 70079.78 | 890505 | no |
| 8/1/2001 10:00 | 72399.00 | 72399.00 | 890506 | no |
| 8/1/2001 11:00 | 73726.81 | 73726.81 | 890507 | no |
| 8/1/2001 12:00 | 75526.05 | 75526.05 | 890508 | no |
| 8/1/2001 13:00 | 77373.59 | 77373.59 | 890509 | no |
| 8/1/2001 14:00 | 79559.47 | 79559.47 | 890510 | no |
| 8/1/2001 15:00 | 80846.89 | 80846.89 | 890511 | no |
| 8/1/2001 16:00 | 81021.31 | 81021.31 | 890512 | no |
| 8/1/2001 17:00 | 79413.52 | 79413.52 | 890513 | no |
| 8/1/2001 18:00 | 76064.63 | 76064.63 | 890514 | no |
| 8/1/2001 19:00 | 73599.37 | 73599.37 | 890515 | no |
| 8/1/2001 20:00 | 71103.00 | 71103.00 | 890516 | no |
| 8/1/2001 21:00 | 70816.36 | 70816.36 | 890517 | no |
| 8/1/2001 22:00 | 70928.12 | 70928.12 | 890518 | no |
| 8/1/2001 23:00 | 67272.43 | 67272.43 | 890519 | yes |
| 8/2/2001 0:00 | 62997.70 | 62997.70 | 890520 | yes |
| 8/2/2001 1:00 | 59251.31 | 59251.31 | 890521 | yes |
| 8/2/2001 2:00 | 57144.53 | 57144.53 | 890522 | yes |
| 8/2/2001 3:00 | 55778.92 | 55778.92 | 890523 | yes |
| 8/2/2001 4:00 | 54943.00 | 54943.00 | 890524 | yes |
| 8/2/2001 5:00 | 55031.08 | 55031.08 | 890525 | yes |
| 8/2/2001 6:00 | 57080.95 | 57080.95 | 890526 | yes |
| 8/2/2001 7:00 | 59619.32 | 59619.32 | 890527 | yes |
| 8/2/2001 8:00 | 63822.38 | 63822.38 | 890528 | yes |
| 8/2/2001 9:00 | 70572.54 | 70572.54 | 890529 | no |
| 8/2/2001 10:00 | 73667.47 | 73667.47 | 890530 | no |
| 8/2/2001 11:00 | 76423.08 | 76423.08 | 890531 | no |
| 8/2/2001 12:00 | 78928.24 | 78928.24 | 890532 | no |
| 8/2/2001 13:00 | 79586.12 | 79586.12 | 890533 | no |
| 8/2/2001 14:00 | 81052.68 | 81052.68 | 890534 | no |
| 8/2/2001 15:00 | 79305.15 | 79305.15 | 890535 | no |
| 8/2/2001 16:00 | 80498.10 | 80498.10 | 890536 | no |
| 8/2/2001 17:00 | 78450.77 | 78450.77 | 890537 | no |
| 8/2/2001 18:00 | 76552.68 | 76552.68 | 890538 | no |
| 8/2/2001 19:00 | 74929.27 | 74929.27 | 890539 | no |
| 8/2/2001 20:00 | 72351.56 | 72351.56 | 890540 | no |
| 8/2/2001 21:00 | 72379.13 | 72379.13 | 890541 | no |
| 8/2/2001 22:00 | 72934.20 | 72934.20 | 890542 | no |
| 8/2/2001 23:00 | 70262.06 | 70262.06 | 890543 | no |
| 8/3/2001 0:00 | 65950.60 | 65950.60 | 890544 | yes |
| 8/3/2001 1:00 | 61891.10 | 61891.10 | 890545 | yes |
| 8/3/2001 2:00 | 59072.29 | 59072.29 | 890546 | yes |
| 8/3/2001 3:00 | 57245.67 | 57245.67 | 890547 | yes |
| 8/3/2001 4:00 | 55842.01 | 55842.01 | 890548 | yes |
| 8/3/2001 5:00 | 55820.59 | 55820.59 | 890549 | yes |
| 8/3/2001 6:00 | 57727.78 | 57727.78 | 890550 | yes |
| 8/3/2001 7:00 | 58224.82 | 58224.82 | 890551 | yes |
| 8/3/2001 8:00 | 61475.54 | 61475.54 | 890552 | yes |
| 8/3/2001 9:00 | 69498.88 | 69498.88 | 890553 | no |
| 8/3/2001 10:00 | 73063.12 | 73063.12 | 890554 | no |
| 8/3/2001 11:00 | 76210.17 | 76210.17 | 890555 | no |
| 8/3/2001 12:00 | 78737.19 | 78737.19 | 890556 | no |
| 8/3/2001 13:00 | 79518.49 | 79518.49 | 890557 | no |
| 8/3/2001 14:00 | 79074.38 | 79074.38 | 890558 | no |
| 8/3/2001 15:00 | 79683.46 | 79683.46 | 890559 | no |
| 8/3/2001 16:00 | 79526.02 | 79526.02 | 890560 | no |
| 8/3/2001 17:00 | 77906.83 | 77906.83 | 890561 | no |
| 8/3/2001 18:00 | 75911.92 | 75911.92 | 890562 | no |
| 8/3/2001 19:00 | 73571.97 | 73571.97 | 890563 | no |
| 8/3/2001 20:00 | 71340.86 | 71340.86 | 890564 | no |
| 8/3/2001 21:00 | 71024.54 | 71024.54 | 890565 | no |

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

What is claimed is:

1. A method of analyzing a data set, the method comprising the steps of:
selecting a data subset of the data set;
displaying a graphical representation of one or more parameters derived from the data set; and
displaying a graphical representation of one or more parameters derived from the data subset;
wherein the graphical representation of the one or more parameters derived from the data set and the graphical representation of the one or more parameters derived from the data subset are superimposed.

2. The method of claim 1, wherein the graphical representation of the one or more parameters derived from the data subset is superimposed onto the graphical representation of the one or more parameters derived from the data set.

3. The method of claim 1, wherein the step of displaying a graphical representation of the one or more parameters derived from the data set comprises graphically displaying one or more statistical parameters related to the data set.

4. The method of claim 1, wherein the step of displaying a graphical representation of the one or more parameters derived from the data set comprises displaying a box plot of the data set.

5. The method of claim 1, wherein the step of displaying a graphical representation of the one or more parameters derived from the data subset comprises graphically displaying one or more statistical parameters related to the data subset.

6. The method of claim 1, wherein the step of displaying a graphical representation of the data subset comprises displaying a box plot of the data subset.

7. A method of analyzing data, the data comprising a plurality of data sets, the method comprising the steps of:
selecting a data set;
selecting a portion of the selected data set;
displaying a box plot of the selected data set; and
displaying a box plot of the selected portion of the selected data set;
wherein the box plot of the selected portion and the box plot of the selected data set are superimposed.

8. The method of claim 7, wherein the box plot of the selected portion is superimposed onto the box plot of the selected data set.

9. The method of claim 7, wherein the step of selecting a data set comprises accessing a data set previously input.

10. The method of claim 7, wherein the step of selecting a data set comprises a user inputting a data set.

11. The method of claim 7, wherein the step of displaying a box plot of the selected data set comprises displaying a box plot on a computer display.

12. The method of claim 7, wherein the step of displaying a box plot of the selected portion of the data set comprises displaying a box plot on a computer display.

13. A method of analyzing data, the data comprising at least a first data set and a second data set, the method comprising steps of:
selecting a portion of the first data set;
displaying a box plot of the first data set;
displaying a box plot of the selected portion of the first data set, wherein the box plot of the selected portion of the first data set and the box plot of the first data set are superimposed;
selecting a portion of the second data set;
displaying a box plot of the second data set; and
displaying a box plot of the selected portion of the second data set, wherein the box plot of the selected portion of the second data set and the box plot of the second data set are superimposed.

14. The method of claim 13, wherein the box plot of the selected portion of the first data set is superimposed onto the box plot of the first data set.

15. The method of claim 13, wherein the box plot of the selected portion of the second data set is superimposed onto the box plot of the second data set.

16. The method of claim 13, wherein the data further comprises an n^{th} data set and the method further comprises steps of:
displaying a box plot of the n^{th} data set;
selecting a portion of the n^{th} data set; and
displaying a box plot of the selected portion of the n^{th} data set, the box plot of the selected portion of the n^{th} data set superimposed onto the box plot of the n^{th} data set;
wherein n is an integer of at least 3.

17. A computer program storage medium readable by a computing system and encoding a computer program for executing a computer process, the computer process comprising:
allowing a user to select a data set;
allowing a user to select a portion of the selected data set;
displaying a box plot of the selected data set; and
displaying a box plot of the selected portion of the selected data set;
wherein the box plot of the selected portion and the box plot of the selected data set are superimposed.

18. The computer program storage medium of claim 17, wherein the box plot of the selected portion is superimposed onto the box plot of the selected data set.

19. The computer program storage medium of claim 17, wherein the step of displaying a box plot of the selected data set comprises displaying a box plot on a computer display.

20. The computer program storage medium of claim 17, wherein the step of displaying a box plot of the selected portion of the selected data set comprises displaying a box plot on a computer display.
